(19) United States
(12) Patent Application Publication
(10) Pub. No.: US 2002/0170863 A1
(43) Pub. Date: Nov. 21, 2002

(54) Carbon dioxide recycle for immersed membrane

(76) Inventors: Manwinder Singh, Burlington (CA); Scott Lenhardt, Milton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/092,577

(22) Filed: Mar. 8, 2002

Related U.S. Application Data
(60) Provisional application No. 60/276,139, filed on Mar. 16, 2001.

(51) Int. Cl. B01D 29/62

(52) U.S. Cl. 210/798; 210/650; 210/805; 210/194; 210/195.2; 210/407

(57) ABSTRACT

Carbon dioxide, liberated by introducing fouling inhibiting bubbles into a tank containing an immersed membrane module, is captured and returned to the tank by way of the bubbles to minimize increases in pH in the tank water caused by carbon dioxide stripping. Minimizing the pH increase reduces the amount of acid required to produce a desired pH in the tank water or, with scaling feed water, reduces the rate of membrane fouling.

### FIELD OF THE INVENTION

This invention relates to the use of filtering membranes to treat water, and more particularly to the design and operation of reactors which use membranes immersed in tanks and aerated to inhibit fouling.

### BACKGROUND OF THE INVENTION

An immersed membrane apparatus and process is described in U.S. Pat. No. 5,639,373. The immersed membranes are used for separating a permeate lean in solids from tank water rich in solids. Feed water having an initial concentration of solids flows into an open tank containing the immersed membranes to keep the membranes submerged. Filtered permeate passes through the walls of the membranes under the influence of a suction applied to the inside of the membranes. As filtered water is permeated through the membranes and removed from the system, the solids are rejected and accumulate in the tank. These solids are removed from the tank by draining appropriate amounts of tank water containing a high concentration of solids.

Over time, solids foul the pores of the membranes and reduce their permeability. To inhibit this fouling, the membranes in U.S. Pat. No. 5,639,373 are backwashed from time to time and are aerated from beneath the membranes either continuously or periodically. Bubbles rise past the membranes to scrub and agitate them. Although backwashing and aeration inhibit fouling, fouling is not eliminated completely and still occurs. In feed waters of various types, fouling remains a serious problem that interferes with the use of immersed filtering membranes.

### SUMMARY OF THE INVENTION

The inventors have noticed that aerating filtering membranes immersed in a tank liberates carbon dioxide and thereby causes an increase in the pH of the tank water. In some process, such as coagulation, which require a certain and generally low pH, increased acid may need to be applied through to maintain a desired pH. In other process, particularly filtration of well water where the feed water is hard, removing carbon dioxide causes scaling due to CaCO₃ precipitation.

It is an object of the present invention to provide a process and apparatus which captures and recycles gases, particularly carbon dioxide, liberated by aerating an immersed membrane module. It is a further object of the invention to minimize increases in pH in the tank water surrounding an immersed membrane module caused by aeration and, more particularly, by carbon dioxide stripping resulting from aeration. Increases in pH are undesirable for various reasons. For example, membrane performance often suffers at a pH above about 8.0. Processes such as coagulation provide better organic matter removal (which is desirable itself but also improves membrane performance) within certain pH ranges which may be equal to or lower than the pH of the feed water. Hard or scaling feed water (for example, feed water with a Langelier Scaling Index of greater than 0.5) fouls membranes rapidly if its pH is increased. Minimizing a further pH increase through aeration reduces these undesirable effects or reduces the amount of acid required to produce a desired pH in the tank water.

In one aspect, the invention provides a reactor having one or more modules of filtering membranes located within a tank. Feed water is introduced to the tank through a feed inlet. A source of transmembrane pressure to the one or more modules produces a permeate on the insides of the immersed membranes. An aeration system supplies bubbles to the tank to inhibit fouling of the membranes. Retentate is removed from the tank through a retentate outlet. A gas recirculation system collects the off-gas from the tank and returns the collected gases to the tank, typically by returning the collected gases to the aeration system.

Preferably, the gas recirculation system includes a lid closely fitted to the tank so as to collect gases liberated from preferably substantially the entire surface area of the feed water in the tank. Optionally, the lid may be substantially sealed to the tank. The collected gases include carbon dioxide. Preferably, 80% or more of the carbon dioxide liberated from the water in the tank is returned to the tank, preferably through the bubbles. The aeration system may include a gas dryer operable to dry collected gases before they are returned to a blower of the aeration system.

### BRIEF DESCRIPTION OF THE DRAWINGS

Preferred embodiments of the invention will now be described below with reference to the following FIGURE:

FIG. 1 is a schematic representation of a reactor according to an embodiment of the invention.

### DETAILED DESCRIPTION OF THE INVENTION

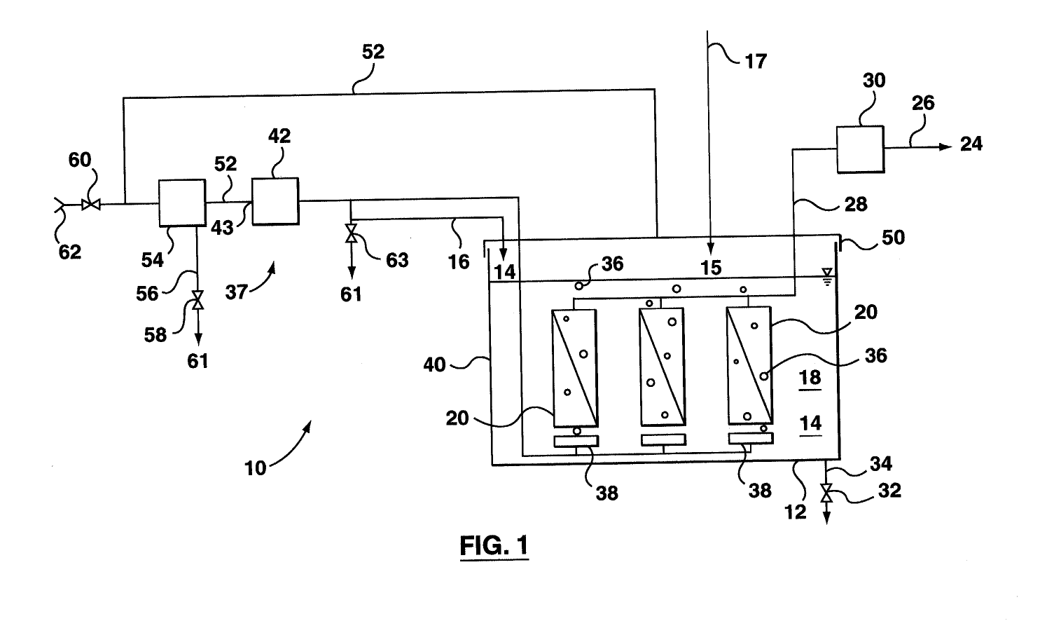

FIG. 1 shows a reactor 10 having a tank 12 which is filled with feed water 14 through an inlet 16. The feed water 14 may contain microorganisms, suspended solids or other matter which will be collectively called solids, although some rejected matter may not actually be solid. The feed water 14 is typically supplied to the tank 12 through a variable speed feed pump or by gravity through a valve. Once in the tank 12, the feed water 14 may still be referred to as feed water 14 but will be also referred to below as tank water 18 because it typically has increased concentrations of the various solids. When treating various feed waters 14, chemical additives 15 may be added through a chemical inlet 17. For example, chemicals may be added to flocculate or coagulate solids or otherwise alter the tank water 18 to make it easier to separate filtered permeate from the solids.

One or more membrane modules 20 are mounted in the tank 12. The membrane modules 20 are made so as to separate an inner surface of the membranes from an outer surface of the membranes. A suitable membrane module 20 is described in U.S. Pat. No. 5,639,373 which is incorporated into this document by this reference. The membrane module 20 described in the '373 patent uses hollow fibre membranes suspended generally vertically between rectangular headers. Other membrane modules 20 may have one or two headers of various shapes and may orient the hollow fibres generally horizontally. Yet other membrane modules 20 may use flat sheet membranes which are typically oriented vertically in a spaced apart pair with headers on four sides and means to communicate with the resulting interior surface. Further, many membrane modules 20 may be joined together to form larger membrane modules 20, or cassettes, but all such configurations will be referred to as membrane modules 20. The membranes in the membrane modules 20 preferably have a pore size in the microfiltration or ultrafiltration range, more preferably between 0.003 and 10 microns.

Commercially available membrane modules 20 include those based on ZW 500 or ZW 650 units made by ZENON Environmental Inc. and referred to in the examples further below. Each ZW 500 or ZW 650 unit has two rectangular skeins of hollow fibre membranes having a pore size of approximately 0.1 microns oriented generally vertically with a total membrane surface area of approximately 47 and 61 square meters respectively.

Filtered water called permeate 24 flows through the walls of the membranes in the membrane modules 20 under the influence of a transmembrane pressure and is transported to a permeate outlet 26 through a permeate line 28. The transmembrane pressure is preferably created by a permeate pump 30 which creates a partial vacuum in a permeate line 28. Feed water 14 flows into the tank 12 as required to keep the membrane modules 20 immersed in tank water 18 typically at all times while the permeate pump 30 is on. The permeate pump 30 or another pump may also be used to backwash the membranes as is known in the art.

As filtered permeate 24 is produced, the membranes in the membrane modules 20 reject solids which remain in the tank water 18. These solids may be removed by draining the tank 12 periodically or continuously to remove a portion of the tank water 18 which is replaced with new feed water 14. To drain the tank, a drain valve 32 is opened in a drain conduit 34 at the bottom of the tank 12.

An aeration system 37 has one or more aerators 38 connected by an air delivery system 40 to one or more air blowers 42 and produces bubbles 36 in the tank water 18. The aerators 38 may be of various types known in the art, for example holes drilled in conduits. The aerators 38 are located generally below the membrane modules 20. The bubbles 36 agitate the membranes which inhibits their fouling or cleans them. In addition, the bubbles 36 also decrease the local density of tank water 18 in or near the membrane modules 20. This creates an air-lift effect and causes tank water 18 to flow upwards past the membrane modules 20 and then downwards along the sides or other parts of the tank 12. The bubbles 36 typically burst at the surface and do not generally follow the tank water 18 back down to the bottom of the tank 12.

The bubbles 36 have an average diameter between 0.1 and 50 mm. Individual large bubbles 36 are believed to be more effective in cleaning or inhibiting fouling of the membranes, but smaller bubbles 36 are more efficient in transferring oxygen to the tank water 18 and require less energy to produce per bubble 36. Bubbles 36 between 3 mm and 20 mm, and more preferably between 5 mm and 15 mm in diameter, are suitable for use in many wastewater applications. If the reactor 10 is used to create potable water or for other applications where oxygen transfer is not required, then bubbles between 5 mm and 25 mm are preferred.

The amount of aeration provided is dependant on numerous factors but is preferably related to the superficial velocity of air flow if aeration is continuous. The superficial velocity of air flow is defined as the rate of air flow to the aerators 38 at standard conditions (1 atmosphere and 20 C) divided by the cross sectional area of aeration. The cross sectional area of aeration is determined by measuring the horizontal area effectively aerated by the aerators 38 which is often roughly one half of the horizontal area of the tank. Superficial velocities of air flow of between 0.01 m/s and 0.15 m/s are preferred with the air supplied continuously or intermittently in cycles of less than about 120 seconds in duration. An average superficial velocity is preferably chosen to achieve a desired effect against fouling without regard to the amount of carbon dioxide that may be released through aeration, because that carbon dioxide will be mostly recycled and returned to the tank water 18.

While scouring the membranes, the bubbles 36 also strip carbon dioxide from the tank water 18 as long as the partial pressure of carbon dioxide in the bubbles is less than that corresponding to the carbon dioxide concentration in the tank water 18, the partial pressure and the concentration being related by Henry's law. The amount of carbon dioxide removed from the tank water 18 if the carbon dioxide is released to the atmosphere is primarily a function of the dissolved carbon dioxide present in the raw water, the hydraulic retention time of the tank 12 and the amount of aeration. For example, carbon dioxide stripping is often significant when filtering groundwater since groundwater is often very high in dissolved carbon dioxide or when filtering surface waters that have had acid added to them.

Shifts in pH of the tank water 18 resulting from carbon dioxide stripping are minimized, however, by capturing and recycling a substantial portion of the carbon dioxide that would otherwise be liberated by aeration. A lid 50 is placed over top of the tank 12. The lid 50 may be a single piece or may be made of several plates, preferably made of aluminum or fiber reinforced plastic, placed over the tank 12 to cover its surface. The lid 50 preferably closely covers the tank 12 but does not need to create an air tight seal with the tank 12. Optionally, however, the lid 50 may be sealed to the tank 12. A recycle line 52 connects the space in the tank 12 between the tank water 18 and the lid 50 with an inlet 43 of the blower 42. Optionally, the inlet 43 of the blower 42 can also intake air from the atmosphere generally through an outside air inlet 62 and an outside air inlet valve 60. Further optionally, gases may be exhausted from the air delivery system 40 through an air exhaust port 61 and an exhaust valve 63. An air dryer 54 is optionally provided in the recycle line 52 upstream of the intake to the blower 42. Further optionally, a drain line 56 which may be opened with a drain valve 58 to release liquids collected by the air dryer 54.

The amount of carbon dioxide recovered can vary depending on the tightness of the lid 50, the extent to which atmospheric air is taken into or gases are exhausted from the aeration system 37 or the tank 12, and the amount of dissolved gases removed from the system by the air dryer, if any. For example, the aeration system 37 can be configured such that the pressure of the gases above the tank water 18 is slightly above atmospheric which causes some carbon dioxide to escape if the lid 50 is not sealed to the tank 12. In this case, the outside air inlet 60 may be used to control the flow of air from the atmosphere into the tank 12 while the exhaust valve 63 is omitted or kept closed. Alternatively, the aeration system 37 can be configured such that the pressure of the gases above the tank water 18 is slightly below atmospheric which causes some air from the atmosphere to enter if the lid 50 is not sealed to the tank 12. In this case, the exhaust valve 63 may be used to control the flow of gases to the atmosphere while the outside air inlet 60 is omitted or kept closed. With the lid 50 sealed to the tank 12, the gases above the tank water 18 may be either slightly above or slightly below atmospheric pressure and the exhaust valve 63, if any, and/or outside air inlet 60, if any, adjusted, if desired, to reduce the amount of carbon dioxide recycled or account for matter removed by the air dryer 54.

Even without a lid 50 completely sealed to the tank 12, typically 80% or more, and more typically 90% or more, of the carbon dioxide liberated to the upper part of the tank 12 is recycled to the aerators 38. While sealing the lid 50 to the tank 12 helps achieve high rates of carbon dioxide recycle, it is also mechanically difficult and costly to achieve in a tank 12 generally designed to hold tank water 18 at ambient pressure. Accordingly, it is often preferable to size and configure the aeration system such that the pressure in the tank 12 above the tank water 18 is very close to ambient pressure and use a lid 50 that is not completely sealed to the tank 12. Further, it is not always desirable to achieve highest possible rate of carbon dioxide recycle. In some cases, particularly when the reactor 10 is the last stage in a treatment process, some carbon dioxide stripping is desirable to reduce the corrosiveness of the permeate 24. In these cases, a more moderate rate of carbon dioxide recycle may be preferred.

Water vapour and will also be entrained in the flow through the recycle line 52. The water vapour is optionally removed by the air dryer 54. The air dryer 54 has a cooling coil which condenses water vapour and rejects the water collected although other types of air driers may be used. Removing water vapour from the recycle line 52 reduces corrosion of the blower 42 but also removes some carbon dioxide which might otherwise be recycled to the tank 12. Thus, alternatively, exposed parts of the blower 42 may be coated with or made of corrosion resistant materials and the air dryer 54 omitted.

### EXAMPLE

A reactor containing 60 ZW 650 ultrafiltration membrane modules in a single tank was used to filter feed well water ultimately intended for use as drinking water. The characteristics of the feed water were as follows:

| | |
|---|---|
| pH | 7.4 to 7.45 |
| Hardness | 350-500 mg/L as CaCO₃ |
| Alkalinity | 250-350 mg/L as CaCO₃ |
| Turbidity | 0.1-0.4 NTU |
| Color | <5 Pt Co. units |

The Langelier Saturation Index of the feed water was greater than 0.5 indicating that the feed water had a tendency to scale. Air was provided continuously at a rate of 15 cubic feet per minute (at standard conditions) of 900 cubic feet per minute total.

During the first two weeks of operation, the pH of the permeate averaged approximately 8.3. The increased pH (over that of the feed water) was believed to be rapidly fouling the membranes by scaling. A lid and recycle loop were installed as described above. Thereafter, the average pH of the permeate dropped to 7.55. The flux was kept substantially constant at between 27 and 29 gfd both with an without carbon dioxide recycle. Before carbon dioxide recycle was added, the average increase in transmembrane pressure to maintain the selected flux was approximately 0.2 psi/day. Following the installation of the carbon dioxide recirculation system, the average rise in transmembrane pressure reduced to approximately 0.11 psi/day.

The invention is not limited to the embodiment described above. For example, the inventors believe that the invention could be adapted to a fully closed system in which the transmembrane pressure is created by pressurizing the feed water. The scope of the invention is defined by the following claims.

We claim:

1. A reactor for filtering water comprising:
(a) one or more modules of filtering membranes located within a tank;
(b) a source of transmembrane pressure to the membranes for withdrawing a permeate from the insides of the immersed membranes;
(c) an aeration system operable to supply bubbles to the tank to inhibit fouling of the membranes;
(d) a feed inlet for introducing feed water to the tank;
(e) a retentate outlet for removing retentate from the tank;
(f) a gas recirculation system to collect one or more gases liberated from feed water in the tank and return the collected gases to the aeration system.

2. The reactor of claim 1 wherein the gas recirculation system includes a lid closely fitted to the tank so as to collect gases liberated from substantially the entire surface area of the feed water in the tank but the tank remains open to atmospheric pressure and the transmembrane pressure is provided by applying a suction to the modules.

3. The reactor of claim 1 wherein the lid is substantially sealed to the tank.

4. The reactor of claim 1 wherein the aeration system further comprises a blower and a gas dryer wherein the gas dryer is operable to dry the collected gases before the collected gases are returned to the blower of the aeration system.

5. A process for filtering a feed water comprising the steps of:
(a) providing a tank containing modules of filtering membranes;
(b) introducing feed water to the tank to keep the modules immersed in feed water in the tank;
(c) withdrawing a filtered permeate from the modules;
(d) withdrawing a retentate from the tank;
(e) introducing bubbles into the water in the tank to inhibit fouling of the membranes, the bubbles also causing increased amounts of gases to be liberated from the water in the tank;
(f) collecting gases liberated from the water in the tank and returning the collected gases to the tank by way of the bubbles.

6. The process of claim 5 wherein the collected gases include carbon dioxide.

7. The process of claim 6 wherein 80% or more of the carbon dioxide liberated from the water in the tank is returned to the tank.

8. The process of claim 7 wherein the feed water in the tank has scaling tendencies.

9. The process of claim 7 wherein the feed water has a Langlier Scaling Index of greater than 0.5 before being introduced into the tank.

10. The process of claim 7 further comprising the step of adding coagulants to the feed water in the tank.

11. The reactor of claims 2 or 3 wherein the gas recirculation system includes and inlet and/or an exhaust to the atmosphere to permit the percentage of liberated gases which are collected to be varied.
